(19) United States
(12) Patent Application Publication
(10) Pub. No.: US 2010/0164878 A1
(43) Pub. Date: Jul. 1, 2010

(54) TOUCH-CLICK KEYPAD

(75) Inventors: Nikolaj Heiberg Bestle, Copenhagen K (DK); Christian Rossing Kraft, Frederiksberg C (DK)

Correspondence Address: Perman & Green, LLP, 99 Hawley Lane, Stratford, CT, 06614, US

(73) Assignee: NOKIA CORPORATION, Espoo (FI)

(21) Appl. No.: 12/347,062

(22) Filed: Dec. 31, 2008

(51) Int. Cl. G06F 3/041

(52) U.S. Cl. 345/173

(57) ABSTRACT

A method includes detecting a short movement of a pointing device on a touch sensitive area of a display; presenting a menu of functions on the display and enabling at least one function on the menu for activation in response to detecting the short movement; and detecting a short press on the touch sensitive area to activate the enabled at least one function.

### CROSS-REFERENCE TO RELATED APPLICATIONS

This application is related to U.S. patent application Ser. No. 12/347,011, filed on Dec. 31, 2008, entitled TOUCH-CLICK KEYPAD, (Attorney Docket No. 684-013681-US(PAR)), the disclosure of which is incorporated herein by reference in its entirety.

### BACKGROUND

1. Field

The aspects of the disclosed embodiments generally relate to user interfaces and more particularly to a user interface for a touch screen device.

2. Brief Description of Related Developments

Generally, touch screen devices can accept gestures for shortcuts, scrolling and letter writing. However, navigation of menus and other functions on these types of devices can be difficult because the pointing device, generally the user's finger, will occupy at least a portion of the screen when providing input to the device. This finger blocking can make it hard to see what your are doing in complex navigation on smaller screens. The user will often need to “step back” (remove finger) between sequences in navigation.

Efficient use of touch screen requires generous size of UI elements which is often missed or impossible in small screens. Additionally, an Output UI (Screen) mixed with Input UI elements (buttons) can be confusing for the user if clickable elements do not having an obvious graphic design, i.e. what can I press? In many situations, it is necessary to maintain a separate select key so that an enable menu or function can be accessed.

It would be advantageous to be able to easily access functions on a touch screen device.

### SUMMARY

The aspects of the disclosed embodiments are directed to at least a method, apparatus, user interface and computer program product. In one embodiment the method includes detecting a short movement of a pointing device on a touch sensitive area of a display; presenting a menu of functions on the display and enabling at least one function on the menu for activation in response to detecting the short movement; and detecting a short press on the touch sensitive area to activate the enabled at least one function.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2A-2B illustrate exemplary user interfaces incorporating aspects of the disclosed embodiments;

FIG. 3 is illustrates an exemplary process including aspects of the disclosed embodiments;

FIG. 4A-4C are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

FIGS. 7A-7E are schematic illustrations of exemplary touch click user interfaces.

### DETAILED DESCRIPTION OF THE EMBODIMENT(S)

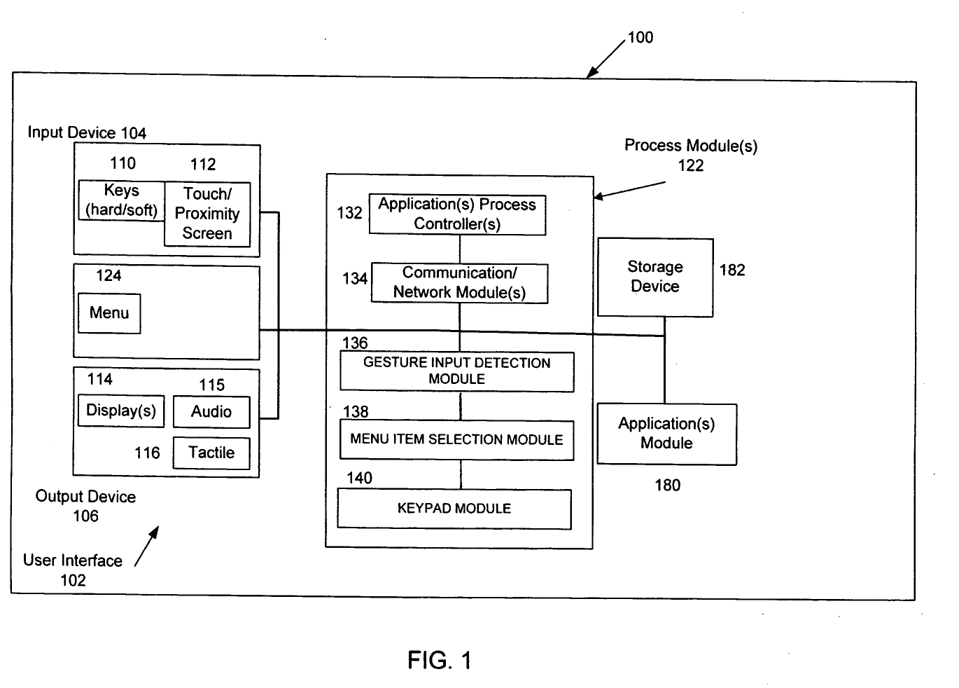

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally provide for selecting a function in a mobile terminal through a touch sensitive keypad with the need for a selection key. In one embodiment, the user performs a gesture on a touch sensitive area of a display, such as a swiping motion, to go to a desired function. The desired function can be selected by a tapping on the touch sensitive area. A keypad that normally occupies the touch sensitive area of the display will disappear from sight when the initial gesture is detected, and re-appear when the gesture movement, or series of movements, is completed.

FIG. 1 illustrates one example of a system 100 incorporating aspects of the disclosed embodiments. Generally, the system 100 includes a user interface 102, process modules 122, applications module 180, and storage devices 182. In alternate embodiments, the system 100 can include other suitable systems, devices and components that allow for associating for selecting a function in a mobile terminal through a touch sensitive keypad with the need for a selection key. The components described herein are merely exemplary and are not intended to encompass all components that can be included in the system 100. The system 100 can also include one or more processors or computer program products to execute the processes, methods, sequences, algorithms and instructions described herein.

In one embodiment, the process module 122 includes a gesture input detection module 136, a menu item selection module 138 and a keypad module 140. In alternate embodiments, the process module 122 can include any suitable function and selection modules for use with a touch sensitive display. In one embodiment, the gesture input detection module 136 is generally configured to detect an input to the touch sensitive display and determine a type and/or nature of the input. For example, in one embodiment, inputs to the touch sensitive area can comprise activation of one or more elements of a keypad that is provided by the keypad module. The inputs to the touch sensitive area can also include commands in the form of gestures or swipes. Different types of gestures or swipes can be used to enable and activate different functions of the system 100.

Based upon the detected command, menu item selection module 136 can enable at least one menu item for selection. For example, in one embodiment, detection of short swipe on at least a portion of the touch sensitive area will open a menu function and cause the menu elements to be displayed. In one embodiment, detection of a short tap on the touch sensitive area can cause the currently enabled menu item to be selected and activated. Thus, a middle “select” key that is commonly seen on devices that include such multifunction and navigation control tools is not required in the device of the disclosed embodiments.

In one embodiment, the process module 122 also includes a keypad module 140. The keypad module 140 can comprise an ITU keypad module that provides an ITU keypad on the touch sensitive area. In alternate embodiments, any suitable keypad or keypad arrangement can be used. The keypad module 140 is generally configured to provide a keypad in the touch sensitive area of the display. If a gesture movement or input is detected by the gesture input detection module that does not correspond to a keypad input, in one embodiment, the keypad module 140 is configured to deactivate or remove the keypad from the visible portion of the touch sensitive area. The keypad module 140 will not reactivate or represent the keypad on the touch sensitive area until after the detected gesture input(s) are completed.

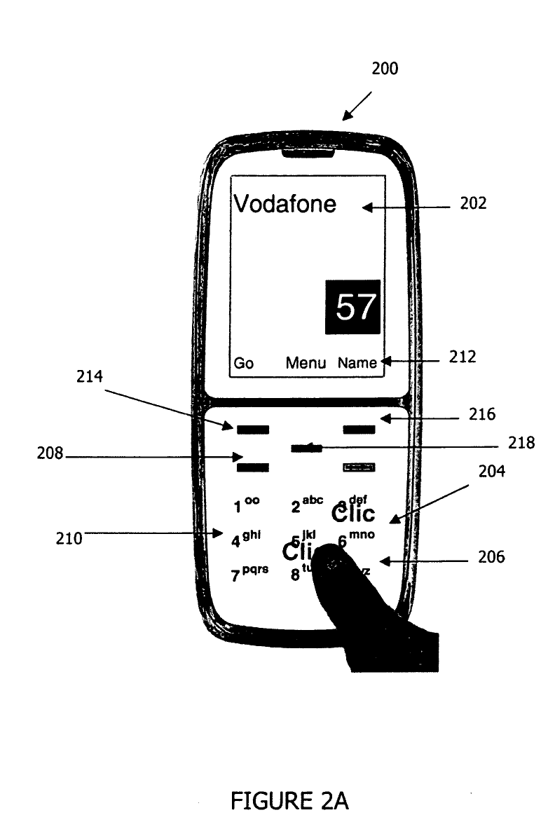

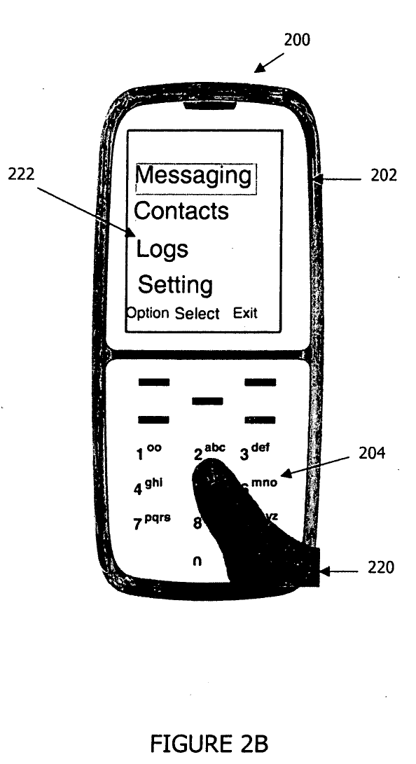

FIGS. 2A-2B illustrate screen shots of exemplary user interfaces incorporating aspects of the disclosed embodiments. As shown in FIG. 2A, the device 200 includes a display area 202 and a touch sensitive area 204. As shown in FIG. 2A, the touch sensitive area 204 includes a keypad 206 and navigation soft keys 208. As is generally understood, activation of any one of the keys 210 of the keypad 206 will activate the corresponding function, such as generating the corresponding number or ITU function. The display area 202 can also include a function area 212 that presents functions that are available to be selected and activated.

As shown in FIG. 2A, in one embodiment these functions can include “Go to”, “Menu” and “Names”. In alternate embodiments, any suitable functions can be presented in the function area 212. In one embodiment, the functions in the function area 212 can be selected using the corresponding navigation keys 208. For example, key 214 can be used to select “Go to” while key 216 can be used to select “Names.” The “Menu” function can be selected by activation of the middle soft key 218. However, it is a feature of the disclosed embodiments to eliminate the need to use the middle soft key 218 for activating a menu and the functions contained therein.

Referring to FIG. 2B, in one embodiment, a pointing device 220, such as a user's finger for example, can be used to generate a movement input on the touch sensitive area 204. The inputs can include for example, a tapping, a short movement or swipe, or a long movement or swipe.

In one embodiment, detection of a short swipe on the touch sensitive area 204 selects the “Menu” function shown in FIG. 2A. As shown in FIG. 2B, the corresponding menu is opened and the menu elements 222 displayed. Although certain exemplary menu elements are shown in FIG. 2B, the aspects of the disclosed embodiments are not so limited and any suitable menu elements can be included.

As shown in FIG. 2B, one of the menu elements 222 is highlighted as being enable for selection. In one embodiment, a short press, such as for example a tap, on the touch sensitive area 204 will select the highlighted menu item, and the corresponding functionality will be activated. This can include opening a file or launching an application, for example.

If another one of the menu elements 222 is desired to be enabled for selection, in one embodiment, detection of another short swipe on the touch sensitive area will cause the next menu item from the menu elements to be highlighted, or enabled for selection. If the enabled menu item is desired to be selected, detection of a tap on the touch sensitive area will cause the enabled menu item to be selected.

In one embodiment, once the user has released the pointer from the touch sensitive area 204, the keypad 206 will be re-presented in the touch sensitive area 204. The selection function described herein will only be available while the user is inputting gestures to the touch sensitive area 204. In one embodiment, upon detection of the input of a gesture, such as the short swipe, the keypad 206 will be hidden or removed from the touch sensitive area. When the gesture is complete, such as when the touch sensitive area 204 is released by the pointing device 220, the keypad 206 will appear in the touch sensitive area. In one embodiment, a pre-determined period of time may elapse from the end of a gesture to the keypad 206 appearing. This is to allow the user to transition from a swipe gesture, for example, to a tap. Once an end to the input of gestures or movements to the touch sensitive area is detected, the keypad 206 will be in view and active on the touch sensitive area until the next gesture input is detected.

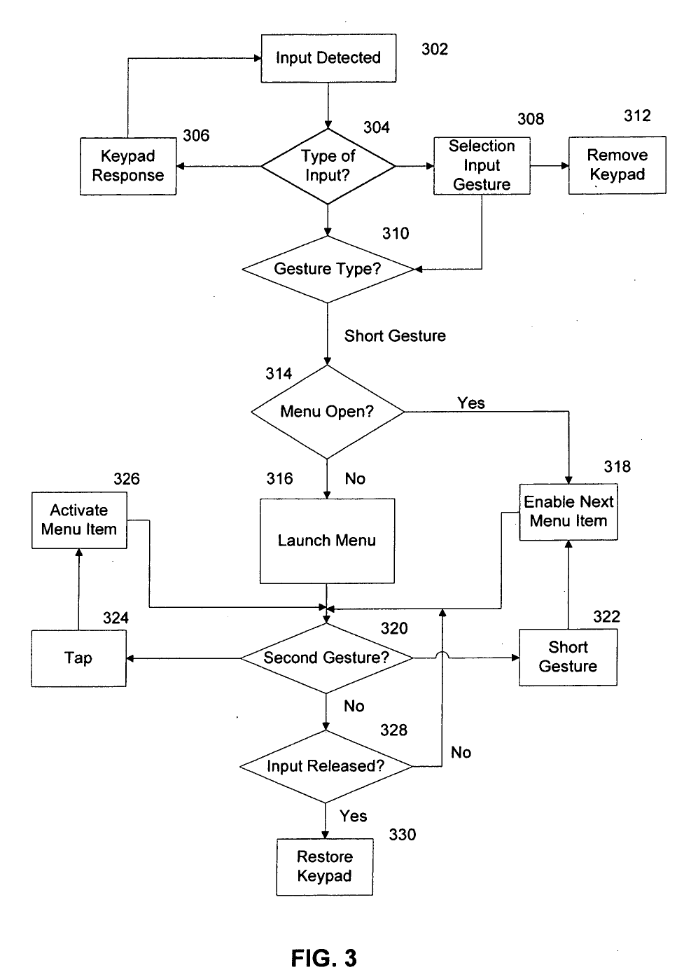

FIG. 3 illustrates an exemplary process incorporating aspects of the disclosed embodiments. In a first aspect, a gesture is detected 302 on a touch sensitive area of a display. It is determined 304 whether the gesture is a keypad input or a selection input gesture. If the gesture is a keypad input, the appropriate keypad response is provided 306. If the gesture is a selection input gesture 308, a form of the selection input gesture is determined 310. In one embodiment, the keypad view and functionality is removed 312 from the touch sensitive area. If the selection input gesture is in the form of a short gesture, it is determined 314 if an application menu is active. If no, an application menu is launched 316 and a next menu item is enabled 318 for selection. In the case where the application menu is launched 316, the first menu item on the menu list will be the next menu item enabled 318. If an application menu is already open, a next menu item in the list of menu items is enabled 318 for selection.

After the menu is launched 316 or a menu item is enabled 318, it is determined 320 whether a second gesture input is detected. If another short gesture 322 is detected, the next menu item on the menu list is enabled 318 for selection. If the detected second gesture is a tap or a short press 324, the enabled menu item is activated.

If no second gesture is detected 320, it is determined 328 whether the gesture input is released. If yes, the keypad view and functionality 320 is restored to the touch sensitive area. If no, the system waits for the next input. The aspects of the disclosed embodiments enable the activation and selection of menus and menu items without the need for a menu soft key.

Referring to FIG. 1, the input device(s) 104 are generally configured to allow a user to input data, instructions, gestures and commands to the system 100. In one embodiment, the input device 104 can be configured to receive input commands remotely or from another device that is not local to the system 100. The input device 104 can include devices such as, for example, keys 110, touch sensitive area or screen 112 and menu 124. The input devices 104 could also include a camera device (not shown) or other such other image capturing system. In alternate embodiments the input device can comprise any suitable device(s) or means that allows or provides for the input and capture of data, information and/or instructions to a device, as described herein.

The output device(s) 106 are configured to allow information and data to be presented to the user via the user interface 102 of the system 100 and can include one or more devices such as, for example, a display 114, audio device 115 or tactile output device 116. In one embodiment, the output device 106 can be configured to transmit output information to another device, which can be remote from the system 100. While the input device 104 and output device 106 are shown as separate devices, in one embodiment, the input device 104 and output device 106 can be combined into a single device, and be part of and form, the user interface 102. For example, the touch sensitive area 204 of FIG. 2 can also be used to present information in the form of the keypad elements of keypad 206. While certain devices are shown in FIG. 1, the scope of the disclosed embodiments is not limited by any one or more of these devices, and an exemplary embodiment can include, or exclude, one or more devices.

The process module 122 is generally configured to execute the processes and methods of the disclosed embodiments. The application process controller 132 can be configured to interface with the applications module 180, for example, and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers and maps. In alternate embodiments, the applications module 180 can include any suitable application. The communication module 134 shown in FIG. 1 is generally configured to allow the device to receive and send communications and messages, such as text messages, chat messages, multimedia messages, video and email, for example. The communications module 134 is also configured to receive information, data and communications from other devices and systems.

In one embodiment, the applications module can also include a voice recognition system that includes a text-to-speech module that allows the user to receive and input voice commands, prompts and instructions, through a suitable audio input device.

The user interface 102 of FIG. 1 can also include menu systems 124 coupled to the processing module 122 for allowing user input and commands and enabling application functionality. The processing module 122 provides for the control of certain processes of the system 100 including, but not limited to the controls for detecting and determining gesture inputs and commands. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100. Depending on the inputs, the process module 122 interprets the commands and directs the process control 132 to execute the commands accordingly in conjunction with the other modules.

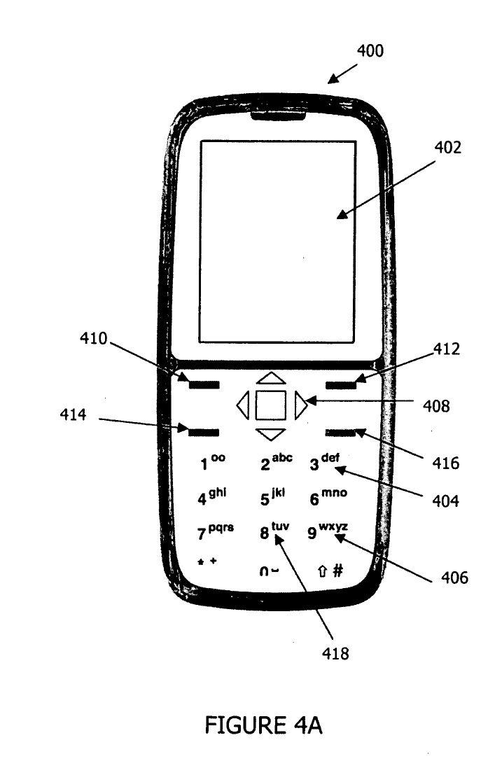

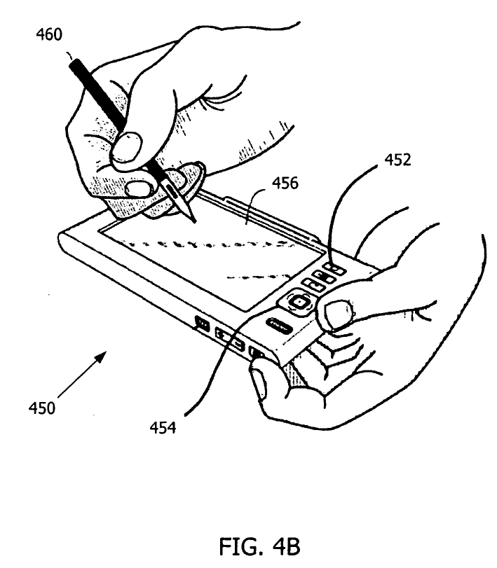

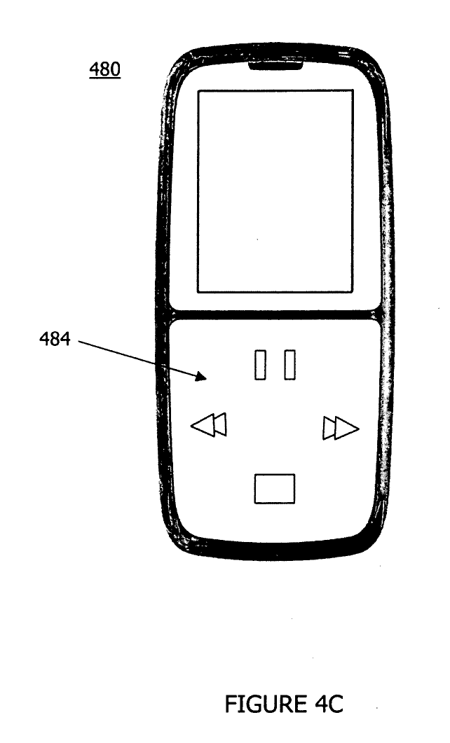

Referring to FIGS. 1 and 4A, in one embodiment, the user interface of the disclosed embodiments can be implemented on or in a device that includes a touch sensitive area, touch screen display, proximity screen device or other graphical user interface.

In one embodiment, the display 114 is integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

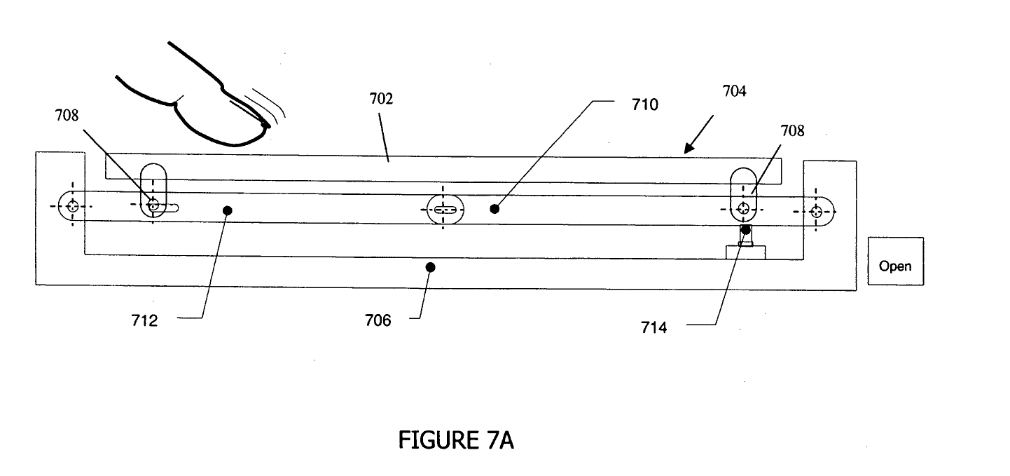

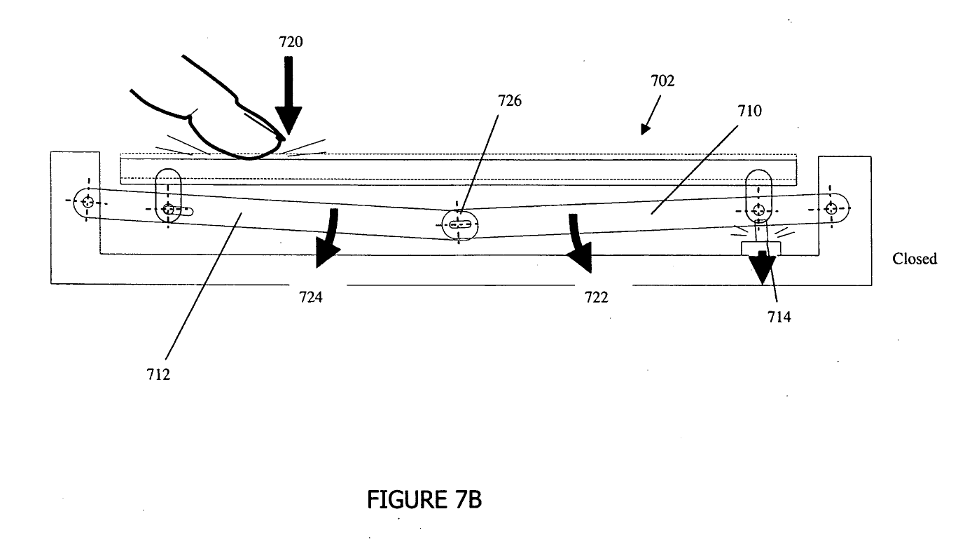

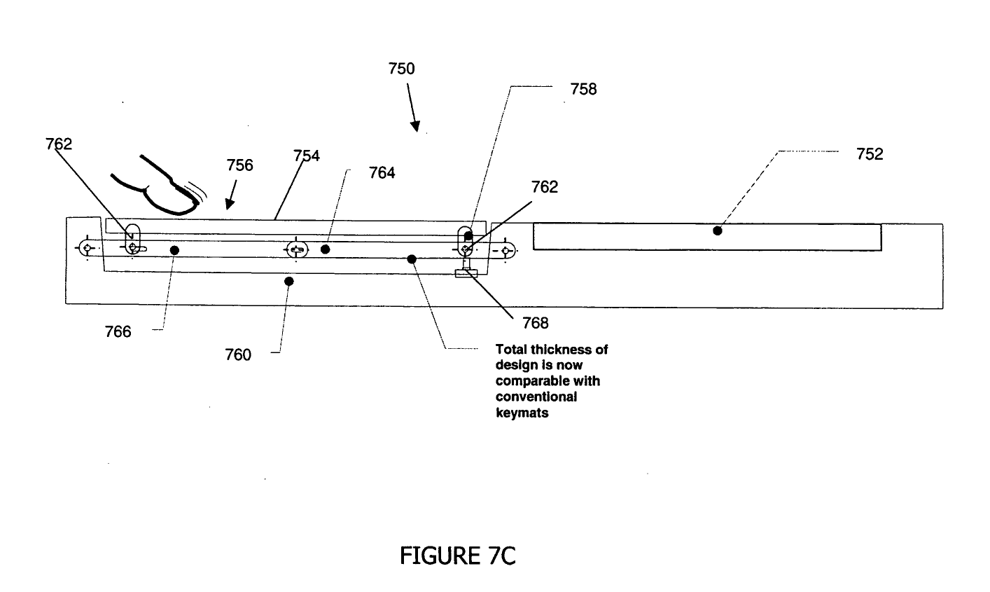

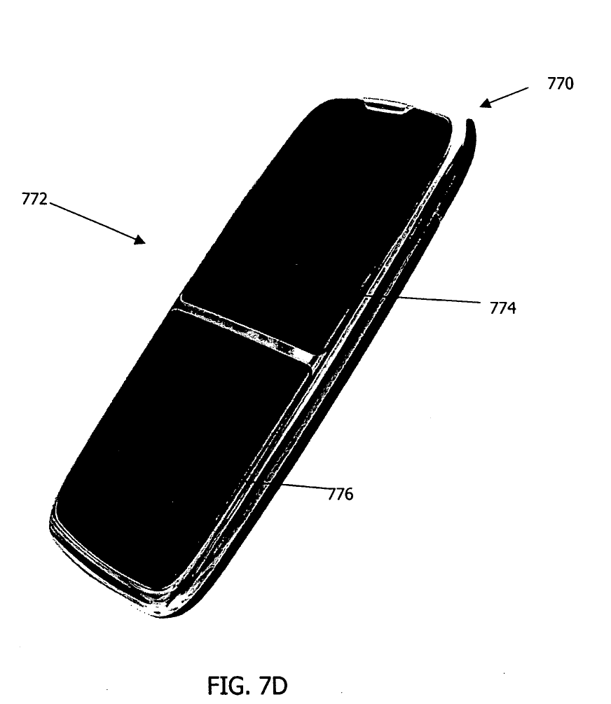

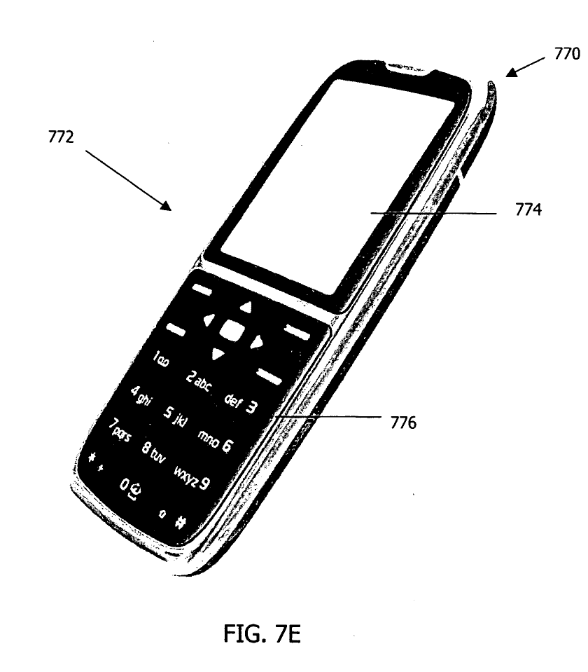

Examples of touch pad and touch-click devices in which aspects of the disclosed embodiments can be practiced are shown in FIGS. 7A-7C. FIG. 7A illustrates an example where the entire display 702 is configured to be a touch pad area, while in FIG. 7C, only the keymat area 752 is configured to be the touch pad area. As shown in FIG. 7A, a display 702 with a frame 704 and exterior body 706 is supported at four places (four feet) 708 connected to two sets of levers, 710, 712, one set in each side. The first lever 710 comprises a main actuator while the second lever 712 comprises a follower. A micro switch actuator 714 can be positioned underneath the main actuator 710 and can be configured to detect movement of the main actuator 710.

In FIG. 7B, a force 720 exerted on the display area 702 causes the entire display to move downward in a parallel movement. This provides a uniform force feedback from the micro switch 714. Each lever 710, 712 generally moves in a respective direction 722, 724, about moment 726.

FIG. 7C illustrates an example where the user interface 750 includes a display 752 and a touch pad area 754. The touch pad area 754 is formed in an area of the user interface 750 that is generally known as the keypad area 756. In this example, the touch pad 754 comprises a frame 758 and exterior body 760. Similar to FIG. 7A, the frame 758 is supported at four places 762 and connected to two sets of levers 764, 766, and includes a micro switch 768. In one embodiment, the total thickness of the design is comparable with conventional keymats.

The touch pad of FIG. 7C can enhance navigation as the display screen always appears at full view. The screen is not blocked by the pointing device, such as the user's fingers. Travel distance of the pointing device can be reduced and multi-toggling with cursors in lists can be faster and easier.

In one embodiment, referring to FIG. 7D, when the device 770 is in an off/idle mode, the entire display surface 772, also referred to as the user interface, can be generally smooth and can present as blank or with a darkened appearance. In this example, there is no immediate visible distinction between the display area 774 and a keypad area 776, as those areas are described herein. Both areas appear generally similar. In an alternate embodiment, the front surface area 772, when in the off/idle mode can present in any desired appearance, other than including a darkened presentation. For example, when the device 770 is in an off/idle mode or state, the front surface area 772 can have a colored appearance, or an off/idle image can be presented on one or both of the areas 774 and 776.

When the device 770 is activated, the front surface 772 of the device can illuminate or light up, using for example, backlit technologies, to present an active view mode or state. As shown in FIG. 7E, when the device 770 is active, the display screen 774 and the keypad display 776 appear in respective areas. In alternate embodiments, any suitable or desired image(s) or screen views can be presented in the active mode of the device 770. In one embodiment, the keypad or keymat area 776 is a single glass surface. As described herein, the keypad area 776, which in one embodiment comprises a touch sensitive area, or touchpad, can accept gestures for shortcuts and scrolling or letter writing. In one embodiment, a single image or view can be presented across an expanse of both of the display screen 774 and the keypad display 776 to appear as a full screen view.

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 has a display area 402 and a touch sensitive area 404. The touch sensitive area 404 can include keypad 406 as an input device. The keypad 406, in the form of soft keys, may include any suitable user input functions such as, for example, a multi-function/scroll key 410, soft keys 410, 412, call key 414, end key 416 and alphanumeric keys 418. In one embodiment, referring to FIG. 4C, the touch screen area 484 of device 480 can also present secondary functions, other than a keypad, using changing graphics.

In one embodiment, the device 400 can include an image capture device such as a camera (not shown) as a further input device. The display 402 may be any suitable display, and can also include a touch screen display or graphical user interface. The display may be integral to the device 400 or the display may be a peripheral display connected or coupled to the device 400. A pointing device, such as for example, a stylus, pen or simply the user's finger may be used in conjunction with the touch sensitive area 404 for cursor movement, menu selection, gestures and other input and commands. In alternate embodiments any suitable pointing or touch device, or other navigation control may be used. In other alternate embodiments, the display may be a conventional display. The device 400 may also include other suitable features such as, for example a loud speaker, tactile feedback devices or connectivity port. The mobile communications device may have a processor 418 connected or coupled to the display for processing user inputs and displaying information on the display 402 and touch sensitive area 404. A memory 420 may be connected to the processor 418 for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 114 shown in FIG. 1, and supported electronics such as the processor 418 and memory 420 of FIG. 4A. In one embodiment, these devices will be Internet enabled and include GPS and map capabilities and functions.

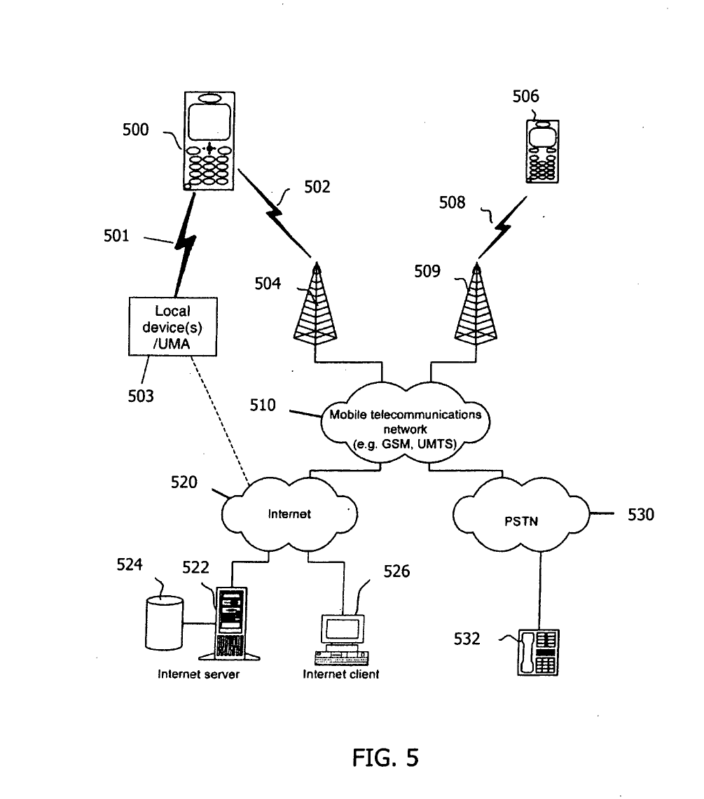

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting, and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 includes communication module 134 that is configured to interact with, and communicate with, the system described with respect to FIG. 5.

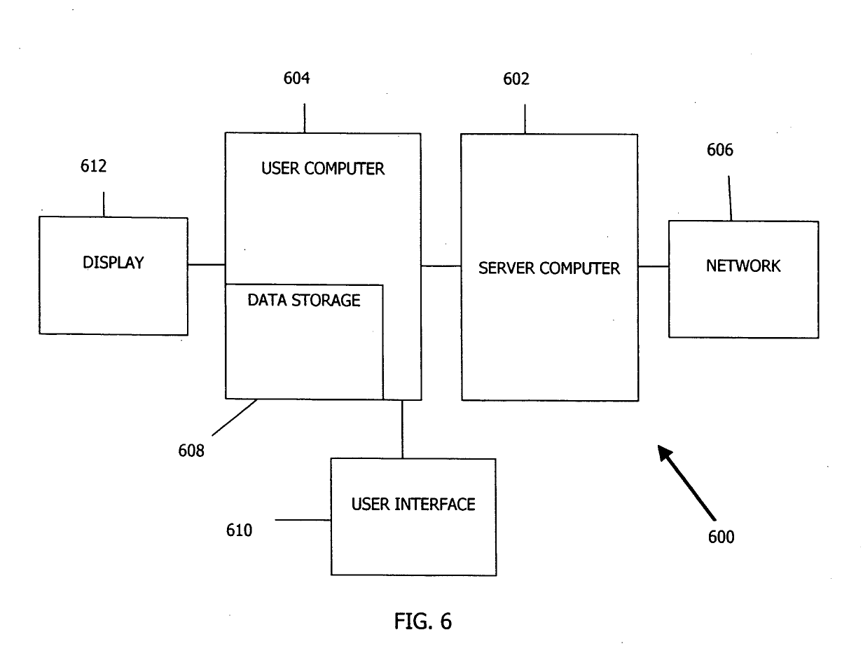

The disclosed embodiments may also include software and computer programs incorporating the process steps and instructions described above. In one embodiment, the programs incorporating the process steps described herein can be executed in one or more computers. FIG. 6 is a block diagram of one embodiment of a typical apparatus 600 incorporating features that may be used to practice aspects of the invention. The apparatus 600 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is adapted to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for enabling and navigating a menu hierarchy without the need for using menu keys. Gesture movements on a touch sensitive area of a device are detected and interpreted. Short gesture movements are used to activate menus and enable menu items for selection. Tapping movements are used to select desired menu items. The touch sensitive area can also function as a keypad when gesture movements are not detected.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
detecting a short movement of a pointing device on a touch sensitive area of a display;
presenting a menu of functions on the display and enabling at least one function on the menu for activation in response to detecting the short movement; and
detecting a short press on the touch sensitive area to activate the enabled at least one function.

2. The method of claim 1 further comprising, after detecting the short movement of the pointing device, removing a keypad view and functionality from the touch sensitive area of the display.

3. The method of claim 2 further comprising re-presenting the keypad view and functionality on the touch sensitive area of the display when the pointing device is removed from the touch sensitive area for at least a pre-determined period of time.

4. The method of claim 1 further comprising, while a menu is presented on the display, detecting at least one other short movement on the touch sensitive area, and enabling a next item in the menu for activation.

5. The method of claim 4 further comprising detecting a short press in the touch sensitive area and activating the selected next item.

6. The method of claim 1 wherein the display area is separate from the touch sensitive area.

7. A computer readable storage medium including computer readable program code means configured to carry out the method according to claim 1.

8. An apparatus comprising:
a touch pad display; and
at least one processing device, the at least one processing device configured to:
detect a short movement of a pointing device on a touch sensitive area of a display;
present a menu of functions on the display and enabling at least one function on the menu for activation in response to detecting the short movement; and
detect a short press on the touch sensitive area to activate the enabled at least one function.

9. The apparatus of claim 8 further comprising that the at least one processor is configured to, after detecting the short movement of the pointing device, remove a keypad view and functionality from a touch sensitive area of the display.

10. The apparatus of claim 10 further comprising that the at least one processor is configured to re-present the keypad view and functionality on the touch sensitive area of the display when the pointing device is removed from the touch sensitive area for at least a pre-determined period of time.

11. The apparatus of claim 8 further comprising that the at least one processor is configured to, while a menu is presented on the display, detect at least one other short movement on the touch sensitive area, and enable a next item in the menu for activation.

12. The apparatus of claim 11 further comprising that the at least one processor is configured to detect a short press in the touch sensitive area and activate the selected next item.

13. The apparatus of claim 8 further comprising that a menu display area is separate from a touch sensitive area of the touch pad display.

14. A user interface comprising:
a keypad input area; and
a display area, wherein the keypad input area is a touch sensitive area and is configured to detect a short movement of a pointing device on the touch sensitive area of a display, present a menu of functions on the display, enable at least one function on the menu for activation in response to detecting the short movement, and detect a short press on the touch sensitive area to activate the enabled at least one function.

15. The user interface of claim 14 further comprising that the keypad input area is further configured, after detecting the short movement of the pointing device, removing a keypad view and functionality from the keypad input area.

16. The user interface of claim 15 further comprising that the keypad input area is further configured to re-present the keypad view and functionality in the keypad input area when the pointing device is removed from the keypad input area for at least a pre-determined period of time.

17. The user interface of claim 14 further comprising, while a menu is presented on the display, detecting at least one other short movement on the keypad input area, and enabling a next item in the menu for activation.

18. The user interface of claim 17 further comprising detecting a short press in the keypad input area and activating the selected next item.
